(19) United States
(12) Patent Application Publication
(10) Pub. No.: US 2014/0244347 A1
(43) Pub. Date: Aug. 28, 2014

(54) SYSTEM AND METHOD OF PROVIDING CONTENT INCLUDING INFORMATION DERIVED FROM A SOCIAL NETWORK

(71) Applicant: Google Inc., Mountain View, CA (US)

(72) Inventor: GREGORY MATTHEW MARRA, San Francisco, CA (US)

(21) Appl. No.: 13/777,463

(22) Filed: Feb. 26, 2013

(51) Int. Cl. G06Q 30/02

(52) U.S. Cl. CPC G06Q 30/0201
USPC 705/7.29

(57) ABSTRACT

Systems and methods of providing information via a computer network are provided. A data processing system can receive a request for third-party content that identifies a first entity. The data processing system can obtain a marketability profile of the first entity based on a social network profile of the first entity and can identify interests of the first entity. The data processing system can identify a third-party content item based on the marketability profile and the social network profile and determine a quality score for the content item. Based on the quality score and a bid value of the content item, the data processing system can select the content item and provide the content item for display. The content item can indicate a second entity, a type of connection between the first entity and the second entity and a type of association between an organization and the second entity.

### BACKGROUND

In a networked environment such as the Internet, users may request access to content of an information resource. In response to the request, content of the information resource can be rendered for display to the user together with third-party content. Users can click on the third-party content to access another information resource associated with the third-party content.

### SUMMARY

At least one aspect is directed to a computer implemented method of providing information via a computer network. A request for third-party content is received by a data processing system. The request identifies a first entity. In response to receiving the request, a marketability profile of the first entity is obtained. In some implementations, the marketability profile is obtained from a database. The marketability profile is based on a social network profile of the first entity. The marketability profile identifies at least one interest of the first entity. The social network profile indicates a second entity, a type of connection between the first entity and the second entity via a social network and a type of association between an organization and the second entity. A plurality of candidate third-party content items are identified based on the marketability profile and the social network profile. A quality score for each of the candidate third-party content items is determined based on the third-party content item and the marketability profile. One of the candidate third-party content items is selected based on the quality score and a bid value of the third-party content item. In some implementations, the selected third-party content item is provided for display. The selected third-party content item indicates i) the second entity, ii) the type of connection between the first entity and the second entity via the social network, and iii) the type of association between the organization and the second entity. In some implementations, the third-party content item provided for display is configured to indicate the second entity, the type of connection between the first entity and the second entity via the social network, and the type of association between the organization and the second entity.

At least one aspect is directed to a system of providing information via a computer network. The system includes a data processing system having at least one of a third-party content generation module and a third-party content selection module. The data processing system receives a request for third-party. The request identifies a first entity. In response to receiving the request, the data processing system obtains a marketability profile of the first entity. In some implementations, the marketability profile is obtained from a database. The marketability profile is based on a social network profile of the first entity. The marketability profile identifies at least one interest of the first entity. The social network profile indicates a second entity, a type of connection between the first entity and the second entity via a social network and a type of association between an organization and the second entity. The data processing system identifies a plurality of candidate third-party content items based on the marketability profile and the social network profile. At least one of the plurality of candidate third-party content items is configured to indicate i) the second entity, ii) the type of connection between the first entity and the second entity via the social network, and iii) the type of association between the organization and the second entity. The data processing system determines a quality score for each of the candidate third-party content items based on the third-party content item and the marketability profile. The data processing system selects one of the third-party content items based on the quality score and a bid value of the third-party content item. In some implementations, the data processing system then provides the third-party content item for display.

At least one aspect is directed to a computer readable storage medium having instructions to provide information for display via a computer network. The instructions include instructions to receive a request for third-party content. The request identifies a first entity. In response to receiving the request, a marketability profile of the first entity is obtained. In some implementations, the marketability profile is obtained from a database. The marketability profile is based on a social network profile of the first entity. The marketability profile identifies at least one interest of the first entity. The social network profile indicates a second entity, a type of connection between the first entity and the second entity via a social network and a type of association between an organization and the second entity. A plurality of candidate third-party content items are identified based on the marketability profile and the social network profile. A quality score for each of the candidate third-party content items is determined based on the third-party content item and the marketability profile. One of the third-party content items is selected based on the quality score and a bid value of the third-party content item. In some implementations, the third-party content item selected for display is configured to indicate the second entity, the type of connection between the first entity and the second entity via the social network, and the type of association between the organization and the second entity. In some implementations, the selected third-party content item is provided for display.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is a block diagram depicting an example environment for providing information via a computer network, according to an illustrative implementation;

FIG. 2 is an example third-party content item for display at a user computing device associated with a first entity according to an illustrative implementation;

FIG. 3 is an example third-party content item template associated with a third-party content item, according to an illustrative implementation;

FIG. 4 is a flow diagram depicting a method of providing information via a computer network, according to an illustrative implementation; and

FIG. 5 is a block diagram illustrating a general architecture for a computer system that may be employed to implement various elements of the systems and methods described and illustrated herein, according to an illustrative implementation.

### DETAILED DESCRIPTION

Following below are more detailed descriptions of various concepts related to, and implementations of, methods, apparatuses, and systems of providing information via a computer networked environment. The various concepts introduced above and discussed in greater detail below may be implemented in any of numerous ways, as the described concepts are not limited to any particular manner of implementation. Examples of specific implementations and applications are provided primarily for illustrative purposes.

Organizations, such as companies, academic institutions or volunteer organizations can employ online advertising campaigns using content items such as ads to promote their organizations. Users may be more likely to respond to an ad (or other content item) that includes content that is familiar to the user. For example, a user of a social network may be more interested in content items that indicate an association between the content item and other users that are connected to the user via the social network. For example, a content item provided by an organization, such as a business having the nameStartup42.com that includes content stating: “Mike, your friend Tina works at Startup42.com” may be more likely to receive a response from the user (e.g., Mike) than another content item provided by the organization for display to Mike that does not include such content. Thus, the systems and methods described herein can identify, select, or provide third-party content to a user that includes public information associated with other users that are connected to the user via a social network. The public information can include information that users of a social network elect to share with others via the social network.

The systems and methods of this disclosure can provide third-party content items (e.g., ads) for display on an information resource (e.g., web page) accessed by a first entity (e.g., a first user such as Mike) using a computing device. The third-party content item can identify an organization, a type of association between the organization and a second entity (e.g., a second user such as Tina), and a type of connection between the second entity (e.g., Tina) and the first entity (e.g., Mike) via a social network.

For example, the first user, via a computing device, can request access to a web page of a content publisher. The content publisher can receive the access request and in response can send a request to a data processing system (e.g., a content placement server) for a third-party content item such as an ad to display with a rendering of the web page. The request for a third-party content item can include information identifying the first user. For example, the information can include a cookie or other object identifying the first user that the first user has elected to provide as part of the request for content. In some implementations, the information identifying the first user can be associated with a social network profile of the first user.

For situations in which the systems discussed here collect personal information about users, or may make use of personal information, the users may be provided with an opportunity to control whether programs or features that may collect personal information (e.g., information about a user's social network, social actions or activities, a user's preferences, or a user's current location), or to control whether and/or how to receive content from the content server that may be more relevant to the user. In addition, certain data may be anonymized in one or more ways before it is stored or used, so that personally identifiable information is removed when generating parameters (e.g., demographic parameters). For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

The data processing system can obtain a marketability profile of the first user, e.g., from a database in response to the request for a third-party content item received from the content publisher. The marketability profile can be based on online activities of computing devices, as well as available information from the first user's social network profile. For example, the marketability profile of the first user can include information about second users that are connected to the first user via the social network. The information about at least one of the second users can include information that the second user has elected to share via the social network, such as organizations with which the second user is associated. For example, the information can include organizations where the second user works or has previously worked, academic organizations where the second user is or was enrolled, or organizations where the second user is or has participated as a volunteer. The association may be determined from direct identification of the organization provided to the social network by the second user, or from information such as an email address provided to the social network by the second user.

The data processing system can identify third-party content items based on the marketability profile. For example the third-party content item can be configured to indicate that the first user is connected to the second user via the social network, and to indicate the type of association between the organization (e.g., a business) and the second user. The data processing system can identify third-party content items of organizations that have an interest in marketing towards the first user (based on information in the marketability profile of the first user). In this example, the data processing system can identify second users connected to the first user via the social network and can determine that the second users are (or are not) associated with the organizations. The data processing system can determine that an organization has an association with a second user, and can generate or obtain (e.g., from a third-party content item publisher) a third-party content item that can indicate a connection between the first user and the second user, or that can indicate a type of association between the second user and the organization. In some implementations, the data processing system can identify the type of connection between the second users and the first user. The data processing system can generate or obtain a third-party content item that can be displayed by a computing device with an indication of a type of connection between the second user and the first user.

The data processing system can determine a quality score for the third-party content items, based for example on the third-party content item and the marketability profile of a user. The quality score can indicate a degree of relevance between the third-party content item and interests of the user. The data processing system can select the third-party content item based on the quality score or other information such as a bid value of the third-party content item, and can provide the selected third-party content item for display at a computing device associated with the first user.

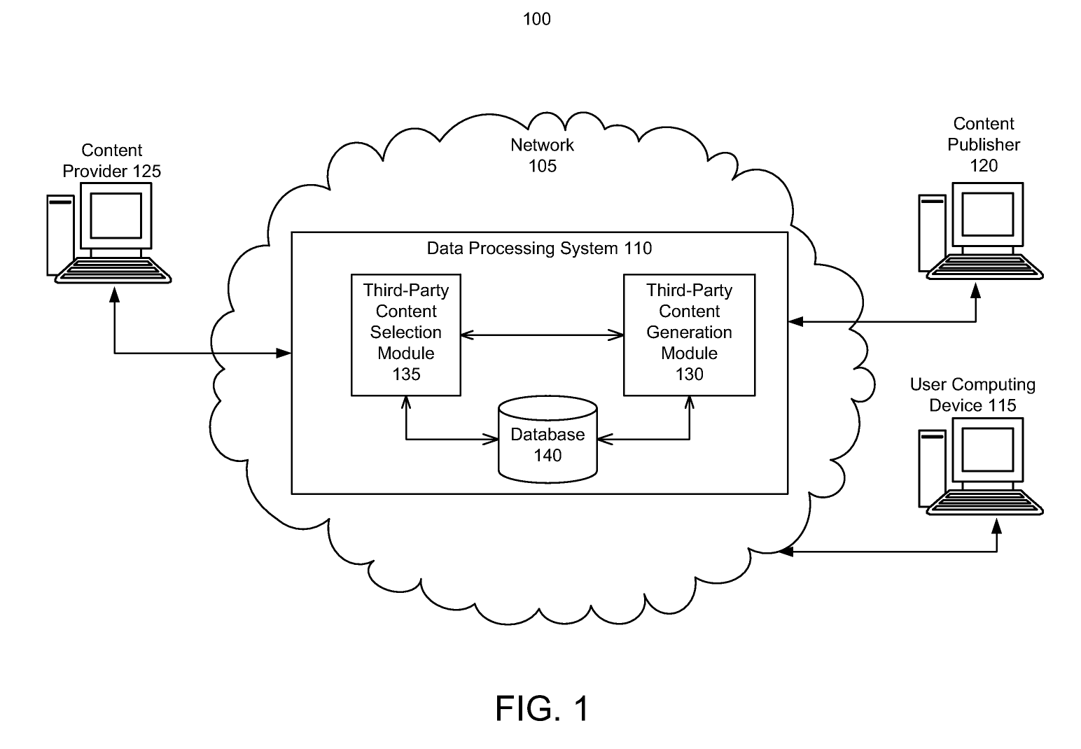

FIG. 1 illustrates an example system 100 of providing third-party content via at least one computer network such as network 105 using information derived from an online social network. In particular, the system 100 can provide one or more third-party content items (e.g., ads) for display at a computing device associated with a first entity, for example a first user. The third-party content items can include information identifying a second entity, for example a second user that is connected to the first user via a social network, an organization (such as a business, an employer, an academic institution or a volunteer organization), or a type of association between the second user and the organization.

The network 105 can include computer networks such as the Internet, local, metro, or wide area networks, intranets, satellite networks and other communication networks such as voice or data mobile phone networks. The system 100 includes at least one data processing system 110. The data processing system 110 can include at least one processor or other logic device such as a computing device having a processor to communicate via the network 105 with at least one user computing device 115, at least one content publisher 120, and at least one content provider 125. In some implementations, the user computing device 115, the content publisher 120, the content provider 125 and the data processing system 110 can communicate with one another via the network 105.

The data processing system 110 can include at least one server. In some implementations, the data processing system 110 includes a third-party content placement system configured to select or place content items of the content provider 125 for display with the content publisher 120 via the network 105. The data processing system 110 can also include at least one third-party content generation module 130, at least one third-party content selection module 135, and at least one database 140. The third-party content generation module 130 and the third-party content selection module 135 can each include at least one processing unit or other logic device such as programmable logic arrays configured to communicate with the database 140. The third-party content generation module 130 and the third-party content selection module 135 can be separate components, a single component, or part of the data processing system 110. In some implementations, the data processing system 110 includes at least one server of a social network.

The user computing device 115 can be associated with a first entity, such as a first user. The first entity can communicate with one or more of the content publisher 120, the content provider 125 and the data processing system 110 via the user computing device 115. In some implementations, the computing device 115 includes a laptop, desktop, tablet, personal digital assistant, smart phone, or portable computer. A first entity can request content from the content publisher 120 via the user computing device 115. For example, the first entity (e.g., a user of the computing device 115) can request access to a web page or other information resource of the content publisher 120 via the network 105. In response to this request, the content publisher 120 can provide the web page for display at the computing device 115. This request for content can include an identifier or object that allows the content publisher 120 to identify the computing device 115 or the first entity. For example, the identifier can be a cookie placed in a browser of the user computing device 115. Other examples of an identifier include an object associated with an account of the first entity, an IP address, or a media access control identifier (MAC ID). In some implementations, the identifier can be an object that identifies a social network profile of the first entity. For example, the identifier can be a cookie associated with a social network of users corresponding to the social network profile of the first entity. In some implementations, the identifier can be an object that allows one or more of the content provider 125, content publisher 120 or the data processing system 110 to identify the computing device 115.

The social network profile can include social network activity information related to activities of the first entity within the social network. This information can be related to actions taken by the first entity or by other users of the social network on the social network. In some implementations, the first entity or the other users of the social network can make this information available. For example, if the first entity posts a video on a friend's social network page, the post of the video can be included in social network activity information associated with the first entity. In some examples, if a friend of the first entity posts an article on the first entity's social network page, the post of the article can be included in the social network activity information associated with the first entity.

In some implementations, subsequent to receiving the request for content from the computing device 115, the content publisher 120 can communicate with the data processing system 110 via the network 105 to request at least one third-party content item (e.g., an ad). The third-party content items can be displayed together with the web page or other information resource or online document of the content publisher 120 at the computing device 115. For example, the data processing system 110 can receive the request for third-party content from the content publisher 120. The content publisher 120 can receive an identifier identifying the first entity requesting the content via the user computing device 115. The content publisher 120 can send the request for third-party content to the data processing system 110 with information that identifies the first entity associated with the user computing device 115 that requested content from the content publisher 120. In some implementations, the content publisher 120 can instruct the user computing device 115 to provide this information to the data processing system 110.

The request for third-party content received by the data processing system 110 can include information associated with the content requested by the first entity. For example, the content publisher 120 can be an online shoe retailer and the request for content can be a request to access a web page corresponding to shoes being sold by the online shoe retailer. In this example, the content publisher 120 may include information about the requested web page (e.g., information about the shoes) to the data processing system 110. The data processing system 110 can use this information together with social network based information associated with the first entity to identify third-party content that may be displayed together with the primary content, such as the web page about shoes.

The content publisher 120 can receive one or more third-party content items from the data processing system 110 or the content provider 125 and can provide the content requested by the first entity for rendering by the user computing device 115. The content publisher 120 can provide the content requested by the first entity with one or more third-party content items received from the data processing system 110 for display at the user computing device 115. The third-party content items may include information included in an online social network to which the entity at the computing device 115 that requests access to content of the content publisher 120 belongs.

Online social networks generally include an online service or platform (e.g., using the network 105) to support or maintain social structures that include users and the dyadic ties or relationships between users. The users of the online social network can elect to make these relationships and other information publically available, for example to at least some other users of the online social network. A social network of users can be represented as a graph of users connected to each other by any one of a 1-nth order connection. In some implementations, each of the 1-nth order connections is a type of association. The type of association can correspond to an order or degree of connection connecting the two users. For example, the data processing system 110 can determine that two users of the social network have a first order connection if a mutually agreed-upon friend designation amongst the two users exists, rendering the two users as friends on the social network. Two users of the social network have a second order connection if the two users have at least one mutual friend. Two users of the social network have a third order connection if friends of the two users have a mutual friend.

Users of the social network (such as an entity or user at the computing device 115) can have a social network profile. The social network profile of a first entity can include information provided to a social network server, (which may include a server of the data processing system 110) by the user of the social network as well as other public information. At least some users of the social network may access the social network profile of other users, based for example on the dyadic or other relationship between at least two users in the social network.

The social network profiles of the online social network can include user or contact information, such as the user's email address, or other information associated with the user or other entity. The social network profiles can include organizational information that is provided by the entity, for example, an organization where an entity (e.g., a user) is or was employed, an academic institution where an entity is or was enrolled, or a volunteer organization where entity is or was a volunteer. The organizational information can include past, present, or planned future relationships, associations, or affiliations between users of the online social network and organizations such as corporate, educational, or nonprofit entities. Examples of organizations can include a sports team that an entity or user of the social network supports.

The content provider 125 can include at least one server configured to provide third-party content, for example an advertisement, for display at the computing device 115. For example, the content provider 125 can provide the third-party content items via the network 105 to the data processing system 110 where they can be stored in the database 140. The third-party content items can include content slots for insertion of content that identifies a second entity (e.g., a social network friend of a first entity), a type of connection between the first entity and the second entity, or an organization with which the second entity is associated and a type of association between the organization and the second entity. The data processing system 110 can populate content slots or other areas of the third-party content items with this information and provide the populated third-party content items for display at the user computing device 115, for example together with a rendering of a web page of the content publisher 120. In some implementations, the data processing system 110 instructs the content provider 125, the content publisher 120, or the user computing device 115 to populate the content slots of the third-party content items for display at the user computing device 115.

The content provider 125 can be a server of an organization implementing a content placement campaign (e.g., ad campaign) to serve third-party content for display on information resources via the network 105. The organization can include, for example, a business, a company, an academic institution, an employer, a volunteer organization, a social network, a website, or other organization with which users of a social network can be associated. Organizations can include institutions whose members or affiliates (e.g., users) work, study, volunteer, participate, endorse, like, dislike, or have an association with the institution.

The data processing system 110 can receive a request for third-party content, for example, from the content publisher 120. The request for third-party content can include information that identifies the user computing device 115 or a first entity requesting content from the content publisher 120. In some implementations, the request can include information associated with the content requested from the content publisher 120 by the first entity. For example, the data processing system 110 can obtain information in a request for third-party content received from the content publisher 120 that indicates the subject matter of the web page as a sports, news, or consumer product web page. The data processing system 110 can identify the computing device 115 or entity requesting the content. For example, the data processing system 110 can receive an identifier from the content publisher 120 that identifies the entity. The identifier can be associated with a social network profile of the entity.

The data processing system 110 can obtain a marketability profile associated with the entity. For example, the marketability profile can be retrieved from the database 140 or a database external to the data processing system 110. In some implementations, the data processing system 110 can generate the marketability profile of entities associated with user computing devices 115.

The marketability profile can indicate interests of the first entity, and can include information identifying the level of interest of an entity or other subject of the marketability profile in a plurality of interest categories, such as an interest in cars. In some implementations, if an entity's level of interest in a particular interest category exceeds a threshold, the data processing system 110 can identify that the entity has an interest in that interest category. The interest categories can include items for which a user can have a preference, inclination, disinclination, or aversion. Example interest categories can include cars, tennis, chocolates, or the color blue.

In some implementations, the data processing system 110 can use information in the marketability profile of an entity to identify third-party content items that may be of interest to that entity. The marketability profile can be based on information that a user or other entity has elected to make available, such as information associated with the social network profile of that entity. For example, the marketability profile can be based on information that a first entity has shared with other users on the social network, such as expressions of an interest in a type of content. For example, the first entity can express an interest by sharing a video related to cars, commenting on a post mentioning a particular celebrity or public personality, or taking an action that indicates to others in the social network that the user is interested in a particular post.

In some implementations, the marketability profile of a first entity can be based on the interests and activities of one or more of the users of the social network that are connected to the first entity via the social network, for example by a first, second or third order relationship via the social network. The marketability profile associated with an entity can also be based on interests and activities of other users of the social network that the other users have elected to share with the entity.

The marketability profile can be based on non-social network related information, such as the content of websites from which the user requests content. In some implementations, the marketability profile includes information related to activities of the user that the user has elected to share with the data processing system 110 for purposes of generating and maintaining the marketability profile. The marketability profile of an entity can be periodically updated based on new information that the entity has elected to share with the data processing system via a social network, recent activity of social network users that are connected to the entity, or previous requests for content originating from the user computing device 115.

The data processing system 110 can identify, create, select, or generate third-party content items based on information from the social network profile of the first entity that the first entity has elected to make available. In some implementations, the data processing system 110 may provide this information to the content provider 125 such that the content provider 125 can generate or identify a third-party content item that includes information from the social network profile of the first entity. The data processing system 110 can also consider available information related to one or more users connected to the first entity to identify third-party content items.

The data processing system 110 can identify content items based on information related to an entity such as a user that the user has elected to share with other users of the social network or with social network servers. For example, a user can provide their email address (e.g., tina@startup42.com) to the social network. From this information, the data processing system 110 can determine that the user is affiliated with an organization “startup42” or that the organization “startup42” is a company where the user works or is likely to work. The third-party content item, e.g., an ad for “startup42” can indicate that the user works at the company.

The data processing system 110 can identify a plurality of candidate third-party content items for display with the content provided by the content publisher 120 based on marketability or social network profiles of one or more entities, such as social network users. For example, the data processing system 110 can identify one or more interests of the first entity from the marketability profile of a first entity. Based on the interests of the first entity, the data processing system 110 can identify third-party content items as candidate content items for display at the user computing device 115, for example, in a content slot of an information resource, such as a web page. The data processing system 110 can store the plurality of third-party content items in the database 140 or can retrieve them from a database of the content provider 125.

The third-party content items can be generated by the third-party content generation module 130. In some implementations, the third-party content generation module 130 updates third-party content items to include additional information, such as social network information that identifies one or more of a second entity, a type of connection between the first entity and the second entity, an organization with which the second entity is associated or a type of association between the organization and the second entity. This information can be inserted into content slots of the third-party content items. The third-party content generation module 130 can update the third-party content item selected for display to include the social network information.

The third-party content items can be associated with meta data, identifiers, or other information that indicates interest categories or subject matter of the third-party content items. From this information, the data processing system 110 can categorize the third-party content items. For example, if the content of the third-party content item is related to luxury yachts, the third-party content item may be categorized as a luxury item, a water vehicle, or in a luxury yachts category. The third-party content selection module 135 or other data processing system 110 component can select third-party content items having interest categories that correspond to marketability profiles of an entity as candidates for display by the user computing device 115.

In some implementations, the data processing system 110 determines a quality score of each of the candidate third-party content items. The quality score can indicate a likelihood that the first entity will engage with or respond to the third-party content item, such as by clicking the content item. In one implementation, the higher the quality score, the more likely the first entity is to engage with the third-party content item. In some implementations, the quality score includes a predicted or estimate click through or conversion rate.

The data processing system 110 can identify the interest categories in which the candidate third-party content item has been categorized. In some implementations, the data processing system 110 can determine a correlation between an interest category and a third-party content item based, for example, on an evaluation of the content of the third-party content item or the identity of the content provider 125 and a ranking of interest categories provided by the content provider 125. In some implementations, the data processing system 110 determines a level of interest of the first entity in an interest category. This can be determined from the marketability profile of the first entity. The data processing system 110 can identify, for each interest category with which the third-party content item has been identified, a degree of correlation between the content of the third-party content item and the particular interest category. In some implementations, using the degree of correlation and the level of interest for each interest category with which the third-party content item has been identified, the data processing system 110 can determine a quality score of the third-party content item with respect to the first entity.

The data processing system 110 can select one of the candidate third-party content items for display at the user computing device 115. In particular, the third-party content selection module 135 can select one of the third-party content items based, for example, on the quality scores of the candidate third-party content items. In some implementations, the third-party content selection module 135 can obtain bid values that correspond to the candidate third-party content items. In some implementations, the bid value generally indicates a monetary amount that the content provider 125 pays per rendering of the content item on an information resource such as a web page. A bid value of a third-party content item can be obtained from a content provider 125 providing the third-party content item or from the database 140. In some implementations, the bid value can be obtained from a database external to the data processing system 110.

In some implementations, the third-party content selection module 135 can select one of the third-party content items based, for example, on the quality scores of the candidate third-party content items and their corresponding bid values. For example, the third-party content selection module 135 can determine a selection score of a third-party content item by multiplying a quality score of a third-party content item and a bid value corresponding to the third-party content item. In some implementations, the third-party content selection module 135 can identify the third-party content item having the highest selection score and select the identified third-party content item to be provided for display.

In some implementations, the third-party content selection module 135 or other data processing system 110 component can determine if there are restrictions on selecting a third-party content item for display. For example, a third-party content item associated with an organization can be sent to entities that have a first order connection with a user (e.g., a friend) that is associated with the organization. The content provider 125 can place restrictions on third-party content items provided by the content provider 125, such as restrictions limiting display of the third-party content items to those content items indicating first order (or other type) of social network connection between entities. Other restrictions can include a type of connection between two or more entities via a social network, or a type of association between an organization and an entity via the social network. The data processing system 110 can receive the restrictions from the content provider 125 together with the third-party content items. In this example, the data processing system 110 can identify the organization with which the third-party content item is associated. The data processing system 110 can also identify one or more entities such as users of the social network that elect to share information indicating an association with the identified organization.

The data processing system 110 can identify users that have, for example, a first order connection with the first entity via the social network. Upon identifying that one or more users have a first order connection with the first entity via the social network, the third-party content selection module 135 can select the third-party content item for display. In some implementations, the third-party content generation module 130 can update the third-party content item to include social network information that indicates the identity of at least one such user, the type of connection between the user and the first entity, or a type of association between the user and the organization. In this example, the data processing system 110 can provide the third-party content item that includes the social network information for display.

In some implementations, the data processing system 110 can provide the selected third-party content item to the content publisher 120 for display at the user computing device 115. For example, the data processing system 110 can retrieve the content item from the database 140 and provide it to the content publisher 120 or the user computing device 115 via the network 105 for display by the user computing device 115. This may occur responsive to a request for content received by the data processing system 110 from the content publisher 120. The third-party content item can be displayed with a web page or other information resource of the content publisher 120. The selected third-party content item can include social network information indicating the identity of a second user, the type of connection between the second user and the first entity or the type of association between the second user and the organization to which the third-party content item corresponds. In some implementations, the selected third-party content item, or a template thereof, can be updated to include the social network information such that when the third-party content item is displayed, the item includes the social network information. For example, prior to display at the user computing device 115, the social network information can be inserted into content slots of the third-party content items. In some implementations, the data processing system 110 can instruct the content provider 125 to provide the selected third-party content item to the content publisher 120 for display.

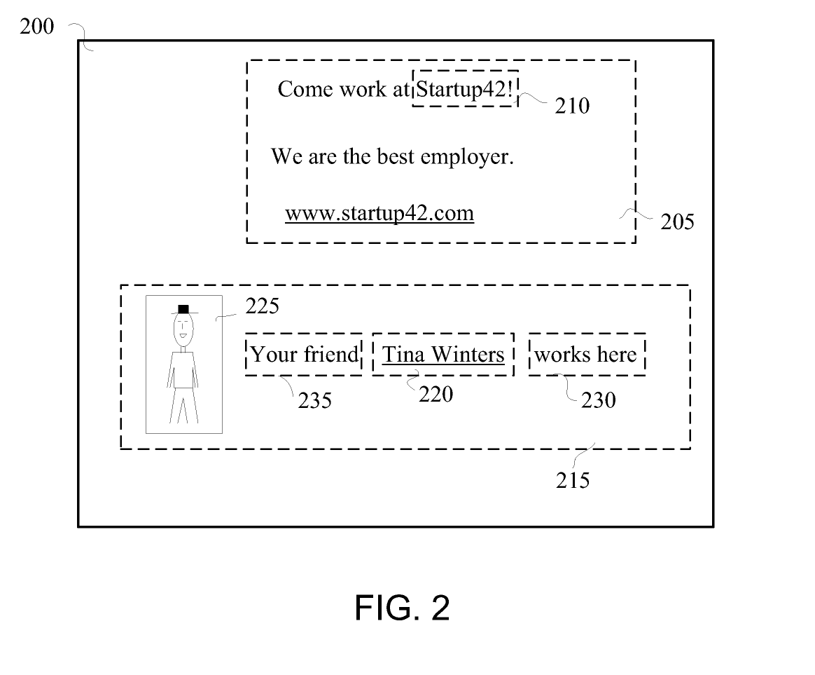

FIG. 2 depicts an example third-party content item 200, such as an ad. The third-party content item 200 can include at least one primary content slot 205 that can be populated with primary content identifying the primary subject matter of the third-party content item 200. For example, if the third-party content item 200 is an ad for an organization, the primary subject matter relates to the organization. The primary content slot 205 of the third-party content item 200 can include at least one organization identifier slot 210 that can be populated with subject matter about the organization, or an organization identifier that identifies an organization (or other institution) associated with the content provider 125. For example, the third-party content item can be associated with the Startup42 organization. In some implementations, the organization identifier slot 210 is an integral part of the primary content slot 205 that can display the primary subject matter of the content item 200, rather than a separate discrete content slot.

The third-party content item 200 can include at least one social network information slot 215. The social network information slot 215 can be populated (e.g., by the data processing system 110) with available social network information. In some implementations, the information can be obtained from the social network profile of a first entity and other entities with which the first entity is connected via the social network. This information may include social network friends of the first entity, types of social network connections between the first entity and other entities, or information about other entities, such as employment educational or volunteer organizations associated with the other entities. In some implementations, the information obtained from the social network profile of another entity is information that the other entity has made available to the first entity via the social network.

In some implementations, the social network information slot 215 includes at least one second user identifier slot 220, at least one image slot 225, at least one association type identifier slot 230, or at least one connection identifier slot 235.

The second user identifier slot 220 can be populated with information indicating a second entity such as a second user of the social network. The data processing system 110 can retrieve the name of the second user from the social network profile of the second user and insert it in the second user identifier slot 220. The image slot 225 can be populated with an icon or image. In some implementations, the image inserted by the data processing system 110 into the image slot 225 can be derived from social network profiles of the social network.

The association type identifier slot 230 can be populated with an association type identifier that indicates the type of association between the second user and the organization indicated in the organization identifier slot 210. Information displayed in the association type identifier slot 230 can indicate a previous or existing association between an entity and the organization. Examples of the association type identifier can include past, present, or planned employment, academic, or volunteer relationships with organizations.

The connection identifier slot 235 can be populated with a connection identifier that indicates a type of connection between the first entity and the second user. For example, the third-party content item 200 can indicate that the first entity and the second user are friends, or that the first entity and the second user have a first degree connection with one another. The social network information can be included in the connection identifier slot 235 or the primary content slot 205.

In some implementations, the second user identifier slot 220, image slot 225, association type identifier slot 230, or connection identifier slot 235 are part of the social network information slot 215, rather than individual slots. The second user identifier slot 220, image slot 225, association type identifier slot 230, or connection identifier slot 235, as well as the social network information slot 215 can also be part of the primary content slot 205. In some implementations, the third-party content item 200 includes more than one social network information slot 215 that can be populated with social network information corresponding to multiple other users that are connected to one entity via the social network and who have a past, present, or planned association with the organization identified by the third-party content item 200.

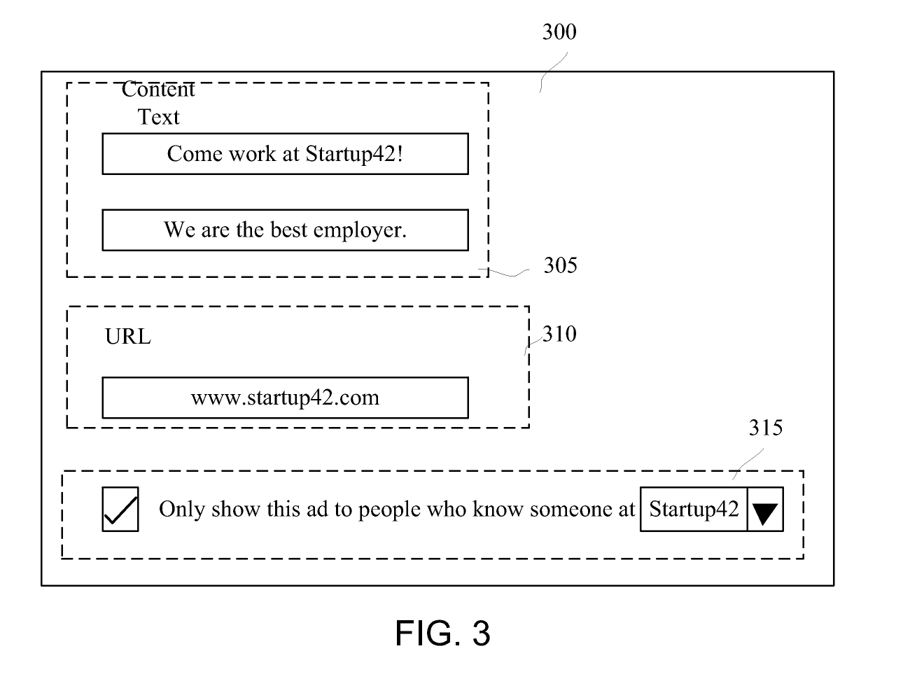

FIG. 3 depicts an example third-party content item template 300 used to create at least one third-party content item, such as the third-part content item 200. In some implementations, to create an online content placement campaign via the network 105, the data processing system 110 provides the content item template 300 to the content provider 125. The content provider 125 interfaces with the content item template 300 by providing information such as primary content (e.g., the subject of an ad) that appears in the primary content slot 205 when the third part content item 200 is displayed at the computing device 115.

The third-party content item template 300 can include at least one primary content interface 305, a link interface 310 and at least one restriction interface 315. The content provider 125 can populate the primary content interface 305, the destination link interface 310, or the restriction interface 315 with responses and submit the completed third-party content item template 300 to the data processing system 110. In some implementations, the third-party content item template 300 can be completed by the data processing system 110. For example, the data processing system 110 can retrieve an image or icon from the database 140 and insert it into the image slot 225.

The primary content interface 305 can include one or more fields that, when populated for example by the content provider 125, indicate the primary content of the third-party content item. For example, the information provided in the primary content interface 305 can be used to populate the primary content slot 205 of the third-party content item 200 depicted in FIG. 2.

The destination link interface 310 can include one or more fields that, when populated, can be used to generate a link for the third-party content item. The link may appear as part of the third-party content item. In some implementations, the link can be associated with the third-party content item such that the link is accessed when the third-party content item is clicked. In some implementations, the link is a URL to a website operated by an organization that operates the content provider 125 that submitted the completed third-party content item template 300 to the data processing system 110.

The restriction interface 315 can include one or more icons or interfaces that allow the content provider 125 to limit the distribution of the third-party content item 200. The selectable icons can correspond to one or more restrictions. For example, the restriction interface 315 can present the content provider 125 with the option to restrict display of the third-party content item 200 only to an entity such as a user of a social network who knows someone, as indicated by the social network, having an association with an organization that is the subject of the third-party content item 200.

The restriction interface 315 can include a selectable icon that limits the distribution of the third-party content item 200 generated from the third-party content item template 300 to users who have a connection via a social network with another user that is associated with the organization. The third-party content item template 300 can include additional selection components that restrict the distribution of third-party content items to specific users. For example, the third-party content item template 300 can include an additional restriction interface that, when selected or activated, limits the distribution of the third-party content item to users that have a friend or other order connection that worked, works, or plans to work (e.g., a type of association) at an organization. In one implementation, the restriction interface 315 restricts display of content items by requiring display of the content items with an indication of a type of association between an organization (e.g., the subject of the content item) and at least one user of the social network.

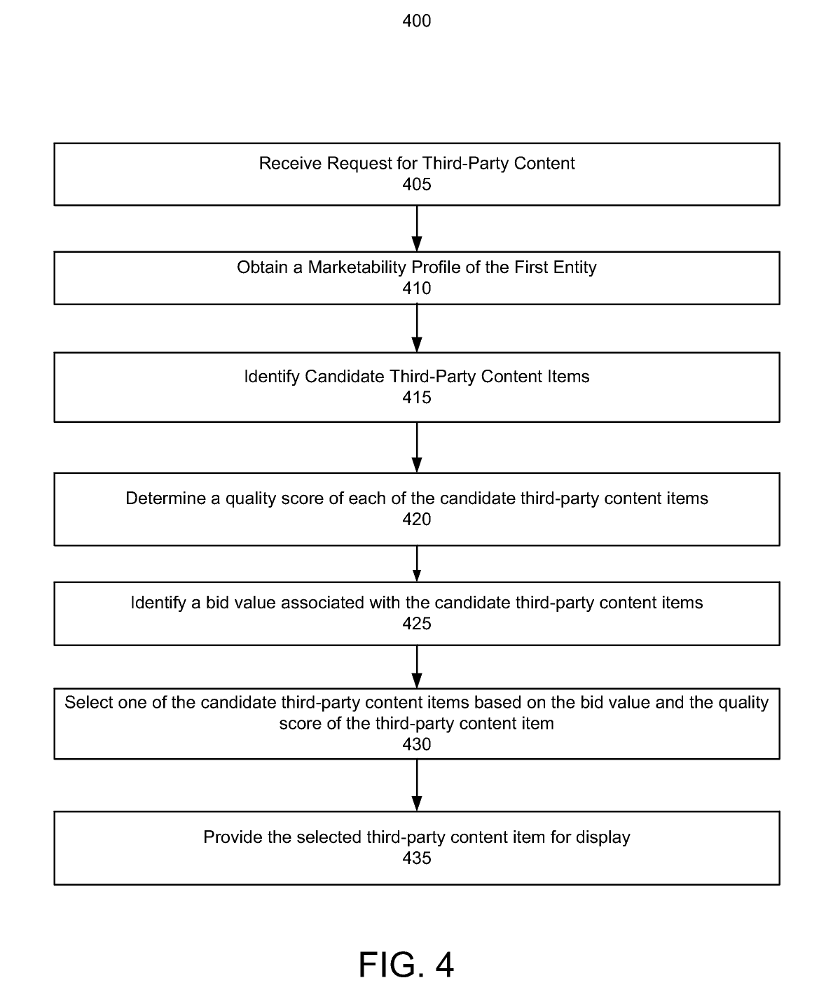

FIG. 4 illustrates an example flow diagram depicting a method 400 of providing information via a computer network. In one implementation, the method 400 can include an act of receiving a request for third-party content (BLOCK 405). For example, a data processing system can receive a request for third-party content (BLOCK 405) to display at a computing device via a computer network. In some implementations, the data processing system receives the request for third-party content (BLOCK 405) from the content publisher. In some implementations, the content publisher receives a request for content from a user computing device, and can serve the request by retrieving primary content from a data repository (such as a database or server) and by requesting third-party content, such as an ad from the data processing system. The request for third-party content can include information identifying a first entity associated with the user computing device. In some implementations, the content publisher receives the information identifying the user from the user computing device along with the request for content. The data processing system can receive a request for third-party content (BLOCK 405) from the user computing device.

The method 400 can also include an act of obtaining a marketability profile of an entity (BLOCK 410). For example, the data processing system can determine an identifier of a computing device that requests content from a content publisher via the Internet. In some implementations, the data processing system can receive identifying information along with the request for third-party content (BLOCK 405) and can obtain the marketability profile (BLOCK 410) associated with this information.

The method 400 can include an act of identifying third-party content items (BLOCK 415). For example, the data processing system can identify third-party content items as candidates for display by a computing device (BLOCK 415) based on the marketability profile of the first entity. For example, the marketability profile can indicate interests of the first entity, and the data processing system can identify third-party content items based on these interests, e.g., third part content items having subject matter similar or related to these interests can be selected. The third-party content items displayed by a computing device to a first entity can include information that identifies a second entity, a type of connection between the first entity and the second entity, an organization with which the second entity is associated, or a type of association between the organization and the second entity.

In some implementations, the data processing system can identify third-party content items (BLOCK 415) as candidates for display to an entity by identifying third-party content items that are categorized in one or more interest categories that match interests of the entity. For example, the data processing system can identify third-party content items (BLOCK 415) associated with an interest category related to tennis based on information in the marketability profile that indicates an interest in racket sports.

The method 400 can include an act of determining a quality score of each of the candidate third-party content items (BLOCK 420). The quality score can be determined (BLOCK 420) by the data processing system based on an indication or degree of relevance between the third-party content item and the first entity. In some implementations, the quality score can be determined (BLOCK 420) based on an indication of relevance between the organization and the at least one interest of the first entity.

To determine a quality score of third-party content items (BLOCK 420), the data processing system can identify the interest categories of the third-party content items, and can determine a correlation between the interest category and the third-party content item. The quality score of third-party content items (BLOCK 420) can be determined based on a level of interest of a user or other entity in the particular interest category, for example as indicated by a corresponding marketability profile.

The method 400 can include an act of identifying a bid value associated with each of the candidate third-party content items (BLOCK 425). In some implementations, the data processing system can receive the bid value of a particular third-party content item from the content provider providing the third-party content item. In some other implementations, the data processing system 110 can determine a bid value for each of the candidate third-party content items.

The method 400 can include an act of selecting a third-party content item for display at a computing device (BLOCK 430). The selection can be based on the bid value and quality score of the third-party content item. The data processing system can determine a selection score for each of the third-party content items. The third-party content item having the highest selection score can be selected (BLOCK 430) for display at a computing device. In some implementations, the data processing system selects a third-party content item (BLOCK 430) having restrictions such as a limitation that the third-party content item is displayed by a computing device to a first entity with an indication of a first (or other) order connection with a second user via a social network, where the second user has an association with an organization that is the subject of the third-party content item.

The method 400 can include an act of providing the selected third-party content item for display (BLOCK 435). In some implementations, the data processing system can provide the selected third-party content item (BLOCK 435) to the user computing device via the network for display at the user computing device to a user or other entity. The selected third-party content item can include the social network information indicating the identity of a second user, the type of connection between the second user and the first entity or a type of association between the second user and an organization to which the third-party content item corresponds.

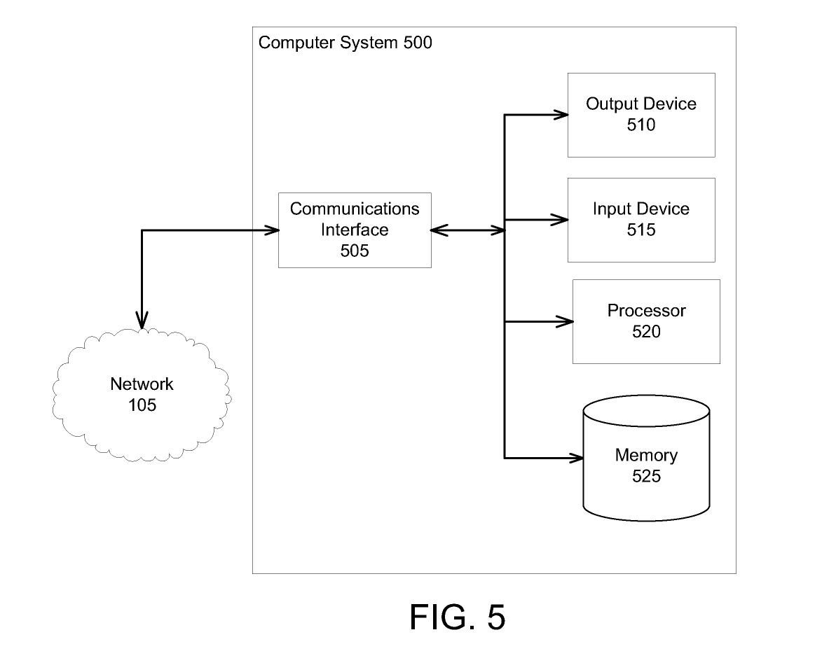

FIG. 5 shows the general architecture of an illustrative computer system 500 that may be employed to implement any of the computer systems discussed herein (including the system 100 and its components such as the third-party content generation module 130 and the third-party content selection module 135) in accordance with some implementations. The computer system 500 can be used to provide information via the network 105 for display. The computer system 500 of FIG. 5 comprises one or more processors 520 communicatively coupled to memory 525, one or more communications interfaces 505, and one or more output devices 510 (e.g., one or more display units) and one or more input devices 515. The processors 520 can be included in the data processing system 110 or the other components of the system 100 such as the third-party content generation module 130 and the third-party content selection module 135.

In the computer system 500 of FIG. 5, the memory 525 may comprise any computer-readable storage media, and may store computer instructions such as processor-executable instructions for implementing the various functionalities described herein for respective systems, as well as any data relating thereto, generated thereby, or received via the communications interface(s) or input device(s) (if present). Referring again to the system 100 of FIG. 1, third-party content generation module 130 and the third-party content selection module 135 can include the memory 525 to store computing device 115 information, related web service information, one or more third-party content items, one or more marketability profiles, one or more social network profiles and one or more quality scores and corresponding bid values. The memory 525 can include the database 140. The processor(s) 520 shown in FIG. 5 may be used to execute instructions stored in the memory 525 and, in so doing, also may read from or write to the memory various information processed and or generated pursuant to execution of the instructions.

The processor 520 of the computer system 500 shown in FIG. 5 also may be communicatively coupled to or control the communications interface(s) 505 to transmit or receive various information pursuant to execution of instructions. For example, the communications interface(s) 505 may be coupled to a wired or wireless network, bus, or other communication means and may therefore allow the computer system 500 to transmit information to or receive information from other devices (e.g., other computer systems). While not shown explicitly in the system of FIG. 1, one or more communications interfaces facilitate information flow between the components of the system 100. In some implementations, the communications interface(s) may be configured (e.g., via various hardware components or software components) to provide a website as an access portal to at least some aspects of the computer system 500. Examples of communications interfaces 505 include user interfaces (e.g., web pages) having third-party content items (e.g., advertisements) the generated by the third-party content generation module 130 and provided for selection by the third-party content selection module 135.

The output devices 510 of the computer system 500 shown in FIG. 5 may be provided, for example, to allow various information to be viewed or otherwise perceived in connection with execution of the instructions. The input device(s) 515 may be provided, for example, to allow a user to make manual adjustments, make selections, enter data, or interact in any of a variety of manners with the processor during execution of the instructions. Additional information relating to a general computer system architecture that may be employed for various systems discussed herein is provided further herein.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. The program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The features disclosed herein may be implemented on a smart television module (or connected television module, hybrid television module, etc.), which may include a processing module configured to integrate internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate implementations, the features may be implemented on a laptop computer or other personal computer, a smartphone, other mobile phone, handheld computer, a tablet PC, or other computing device.

The operations described in this specification can be implemented as operations performed by a data processing apparatus on data stored on one or more computer-readable storage devices or received from other sources.

The terms “data processing apparatus” “data processing system” “user device” or “computing device” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The third-party content generation module 130 and the third-party content selection module 135 can include or share one or more data processing apparatuses, computing devices, or processors.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), for example. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system such as system 500 or system 100 can include clients and servers. For example, the data processing system 110 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, third-party content generation module 130 and the third-party content generation module 135 can be part of the data processing system 110, a single module, a logic device having one or more processing modules, one or more servers, or part of a search engine.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed only in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same embodiment. Any implementation or embodiment may be combined with any other embodiment, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. For example, the third-party content items can include information derived from information that is accessible by the first entity via information resources other than a social network. In particular, second entities may be connected to the first entity based on information within an email service, which the first entity has elected to share with the data processing system. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A computer implemented method of providing information via a computer network, comprising:
receiving, by a data processing system via the computer network, a request for third-party content, the request identifying a first entity;
obtaining a marketability profile of the first entity, the marketability profile based on a social network profile of the first entity and the marketability profile identifying at least one interest of the first entity, the social network profile indicating i) a second entity, ii) a type of connection between the first entity and the second entity via a social network, and iii) a type of association between an organization and the second entity;
identifying a plurality of third-party content items based on the marketability profile and the social network profile;
determining a quality score for each of the plurality of third-party content items based on content of the third-party content item and the marketability profile; and
selecting a third-party content item from the plurality of third party content items for display based on the quality score and a bid value of the third-party content item, the third-party content item configured to indicate i) the second entity, ii) the type of connection between the first entity and the second entity via the social network, and iii) the type of association between the organization and the second entity.

2. The method of claim 1, wherein a server of the social network provides a computing device associated with the first entity access to information of a social network profile of the second entity.

3. The method of claim 1, wherein a social network profile of the second entity indicates the type of association between the second entity and the organization.

4. The method of claim 3, further comprising:
determining the type of association between the second entity and the organization from an email address of the second social network profile.

5. The method of claim 1, further comprising:
determining the type of association between the organization and the second entity as at least one of a past employment relationship, an existing employment relationship, a past academic relationship, an existing academic relationship, a past volunteering relationship, and an existing volunteering relationship.

6. The method of claim 1, further comprising:
determining the quality score based on at least one of an indication of relevance between the third-party content item and the first entity, and an indication of relevance between the organization and the at least one interest of the first entity.

7. The method of claim 1, further comprising:
identifying the third-party content item based on declared information provided by the second entity to a social network profile of the second entity, the declared information accessible to the data processing system via the social network.

8. The method of claim 1, further comprising:
providing the third-party content item for display, the displayed third-party content item indicating i) the second entity, ii) the type of connection between the first entity and the second entity via the social network, and iii) the type of association between the organization and the second entity.

9. The method of claim 1, wherein the third-party content item is a first content item of the plurality of third-party content items, further comprising:
identifying a subset of the plurality of third-party content items including the first content item, each content item of the subset of third-party content items configured to indicate i) the second entity, ii) the type of connection between the first entity and the second entity, and iii) the type of association between one of a plurality of organizations and the second entity; and
selecting the first content item from the subset.

10. The method of claim 1, further comprising:
identifying, based on the marketability profile, a second content item of the plurality of third-party content items as a candidate content item for display responsive to the request for third-party content;
determining that the second content item is not configured to indicate at least one of i) the second entity, ii) the type of connection between the first entity and the second entity, and iii) the type of association between one of a plurality of organizations and the second entity; and
denying display of the second content item responsive to the request for third-party content.

11. The method of claim 1, wherein the marketability profile indicates at least one of the second entity, the type of connection between the first entity and the second entity, and the type of association between the organization and the second entity.

12. The method of claim 1, further comprising:
providing the third-party content item for display on a social network web page by a computing device associated with the first entity.

13. The method of claim 1, wherein the third-party content item is a first content item of the plurality of third-party content items, the method further comprising:
identifying the plurality of third-party content items based on the marketability profile;
determining individual quality scores for each of the plurality of third-party content items; and
selecting the first content item based on the individual quality scores.

14. A system of providing information via a computer network, comprising:
a data processing system having at least one of a third-party content generation module and a third-party content selection module, the data processing system configured to:
receive, via the computer network, a request for third-party content, the request identifying a first entity;
responsive to the request, obtain a marketability profile of the first entity, the marketability profile based on a social network profile of the first entity and the marketability profile identifying at least one interest of the first entity, the social network profile i) indicating a second entity, ii) indicating a type of connection between the first entity and the second entity via a social network, and iii) indicating a type of association between an organization and the second entity;
identify a plurality of third-party content items based on the marketability profile and the social network profile, at least one of the plurality of third-party content items configured to indicate i) the second entity, ii) the type of connection between the first entity and the second entity via the social network, and iii) the type of association between the organization and the second entity;
determine, for each third-party content item, a quality score based on the third-party content item and the marketability profile;
select one of the third-party content items based on the quality score and a bid value of the selected third-party content item; and
provide the selected third-party content item for display.

15. The system of claim 14, wherein a social network profile of the second entity indicates the type of association between the second entity and the organization.

16. The system of claim 14, further comprising the data processing system configured to:
determine the type of association between the second entity and the organization from an email address of the second social network profile.

17. The system of claim 14, further comprising the data processing system configured to:
determine the type of association between the organization and the second entity as at least one of a past employment relationship, an existing employment relationship, a past academic relationship, an existing academic relationship, a past volunteering relationship, and an existing volunteering relationship.

18. The system of claim 14, further comprising the data processing system configured to:
provide the selected third-party content item for display a request for third-party content, wherein when displayed the selected third-party content item indicates at least one of i) the second entity, ii) the type of connection between the first entity and the second entity, and iii) the type of association between the organization and the second entity.

19. A computer readable storage medium having instructions to provide information via a computer network, the instructions comprising instructions to:
receive a request for third-party content, the request identifying a first entity;
obtain a marketability profile of the first entity, the marketability profile based on a social network profile of the first entity and the marketability profile identifying at least one interest of the first entity, the social network profile indicating i) a second entity, ii) a type of connection between the first entity and the second entity via a social network, and iii) a type of association between an organization and the second entity;
identify a plurality of third-party content items based on the marketability profile and the social network profile;
determine a quality score for each of the plurality of third-party content items based on content of the third-party content item and the marketability profile;
select a third-party content item from the plurality of third-party content items based on the quality score and a bid value of the third-party content item, the selected third-party content item configured to indicate i) the second entity, ii) the type of connection between the first entity and the second entity via the social network, and iii) the type of association between the organization and the second entity; and
provide the selected third-party content item for display.

20. The computer readable storage medium of claim 19, wherein the instructions further comprise instructions to:
determine the type of association between the organization and the second entity as at least one of a past employment relationship, an existing employment relationship, a past academic relationship, an existing academic relationship, a past volunteering relationship, and an existing volunteering relationship.
